(19) United States
(12) Patent Application Publication
(10) Pub. No.: US 2008/0251661 A1
(43) Pub. Date: Oct. 16, 2008

(54) Power Supply Mounting System For Rolling Computer Cart

(76) Inventor: Alfred P. Rossini, Southborogh, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/101,273

(22) Filed: Apr. 11, 2008

Related U.S. Application Data
(60) Provisional application No. 60/911,171, filed on Apr. 11, 2007.

(51) Int. Cl. F16M 11/00

(52) U.S. Cl. 248/176.1

(57) ABSTRACT

A battery power supply mounting system for a rolling computer cart, which includes one or more ramp structures on the cart, located close to the bottom of the cart, and a battery power supply assembly adapted to be mounted to the cart and itself including one or more rechargeable batteries and one or more power supply assembly ramps that directly engage with the one or more ramp structures on the cart as the power supply assembly is mounted on the cart, to lift the battery power supply assembly slightly as it engages with the ramp structures on the cart.

### CROSS REFERENCE TO RELATED APPLICATION

This application claims priority of Provisional Patent Application Ser. No. 60/911,171 filed Apr. 11, 2007, the disclosure of which is incorporated herein by reference.

### FIELD OF THE INVENTION

The invention relates to the mounting of a rechargeable power supply on a rolling cart that carries a computer or other equipment that requires electrical power.

### BACKGROUND OF THE INVENTION

Mobile carts used as workstations are known. These carts are commonly used in medical facilities and on manufacturing floors. They are typically adapted to carry a computer, and usually have additional shelf space available for the user, for such things as paper work, medications, and/or portable electronic equipment.

In order for these carts to be useful mobile computing/workstation devices, they need to carry a power source that can deliver sufficient power to run electronic equipment. Batteries used for these applications are typically fairly heavy; battery packs sufficient for many needs of such carts can weigh on the order of fifty pounds, making them awkward and difficult to install on the cart. There is thus a need for a simple battery pack installation system that does not require great strength, and is unlikely to cause injury to the installer.

### SUMMARY OF THE INVENTION

The invention accomplishes a solution to these problems, by providing a battery power supply mounting system for a rolling computer cart comprising one or more ramp structures on the cart, located close to the bottom of the cart, and a battery power supply assembly adapted to be mounted to the cart and comprising one or more rechargeable batteries and one or more power supply assembly ramps that directly engage with (i.e., slide over) the one or more ramp structures on the cart as the power supply assembly is mounted on the cart. The power supply mounting system may further comprise structure to hold the power supply assembly on the cart after it has been mounted on the cart. The structure may comprise a movable tongue.

The power supply assembly may comprise a battery enclosure that contains one or more batteries, and an electronics case that holds electronic devices used to supply power from the batteries to electrically-powered equipment coupled to or carried by the cart. The power supply assembly may further comprise one or more power supply assembly brackets that mechanically couple together the electronics case and the battery enclosure. The one or more power supply assembly brackets may comprise the one or more power supply assembly ramps. The power supply mounting system may comprise one power supply assembly bracket that carries two spaced power supply assembly ramps.

The ramp structures and the power supply assembly ramps are preferably at an angle of no more than about ten degrees, and more preferably at an angle of about eight degrees. The ramp structures and the power supply assembly ramps in one specific embodiment are about six inches long. Also, in one specific embodiment the ramp structures and the power supply assembly ramps cooperate to hold the power supply assembly less than about one inch off of the floor on which the cart is located. The ramp structures may define stops at their upper ends, to define an end position for the power supply assembly ramps. There may be two spaced ramp structures and two spaced power supply assembly ramps.

Featured in another specific embodiment is battery power supply mounting system for a rolling computer cart comprising two spaced ramp structures on the cart, located close to the bottom of the cart, and a battery power supply assembly comprising a battery enclosure that contains one or more batteries, and an electronics case that holds electronic devices used to supply power from the batteries to electrically-powered equipment coupled to or carried by the cart, and a power supply assembly bracket that mechanically couples together the electronics case and the battery enclosure, in which the power supply assembly bracket comprises the two power supply assembly ramps that directly engage with the two ramp structures on the cart as the power supply assembly is mounted on the cart, to lift the battery power supply assembly slightly as it engages with the ramp structures on the cart.

This embodiment of the power supply mounting system may further comprise structure to hold the power supply assembly on the cart after the power supply assembly has been mounted on the cart. The structure may comprise a movable tongue. The ramp structures and the power supply assembly ramps may be at an angle of no more than about ten degrees, or of about eight degrees. The ramp structures and the power supply assembly ramps may each be about six inches long. The ramp structures and the power supply assembly ramps may cooperate to hold the power supply assembly less than about one inch off of the floor on which the cart is located. The ramp structures may define stops at their upper ends, to define an end position for the power supply assembly ramps.

### BRIEF DESCRIPTION OF THE DRAWINGS

Other objects, features and advantages will occur to those skilled in the art from the following description of embodiments of the invention, and the accompanying drawings, in which:

FIG. 1 is a perspective view of a rolling cart that includes the inventive power supply mounting system;

FIG. 2A is a cross-sectional view of the rolling base assembly of the cart of FIG. 1;

FIG. 2B is a side view of the battery/electronics assembly of the cart of FIG. 1;

FIG. 2C is a side view of the battery/electronics assembly of FIG. 2B mounted on the rolling base of FIG. 2A, to make up the rolling base section;

FIGS. 3A through 3C show various stages of assembly of the rolling base assembly for the cart of FIGS. 1 and 2; and

FIGS. 4A and 4B are top and side views, respectively, of the bracket that couples the electronics assembly to the battery assembly, to create the electronics/battery assembly shown in FIGS. 2B and 2C.

### DETAILED DESCRIPTION OF EMBODIMENTS OF THE INVENTION

This invention features a battery power supply mounting system for a rolling computer cart. The preferred embodiment includes two spaced ramp structures on the cart, located close to the bottom of the cart, and a power supply assembly adapted to be mounted to the cart and comprising one or more rechargeable batteries, and two spaced power supply assembly ramps that directly engage with the ramp structures on the cart as the power supply assembly is mounted on the cart.

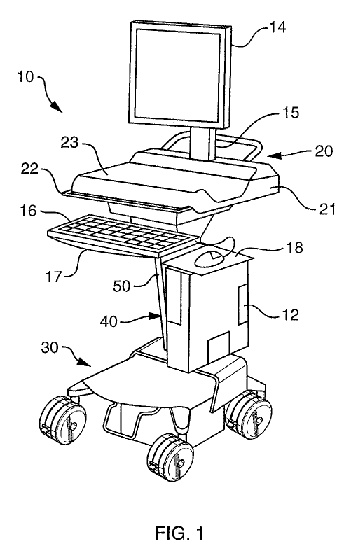

The preferred embodiment of the inventive power supply mounting system for a rolling cart is shown in the drawings. FIG. 1 is a perspective view of a rolling cart that includes the inventive power supply mounting system. Cart 10 comprises rolling base section 30, upper working section 20, and intermediate section 40 that comprises upwardly-extending post 50. Upper section 20 includes keyboard support surface 17 that supports keyboard 16 and includes retractable mouse tray 18. Section 20 further includes upper portion 21 that defines a first shelf or working surface 23 which in this embodiment comprises a removable cover member that exposes a cavity inside of portion 21 that can accommodate a laptop computer, a thin client computer or the like, as desired. Front projecting handle 22 is included to allow the user to easily move the cart, as well as to push down or lift up on upper section 20 to change the height of section 20. In this embodiment, the computing is accomplished with a desktop computer 12 that is coupled to the cart in an appropriate manner. The display is accomplished with a flat panel monitor 14 that projects above portion 21 on post 15. Sections 20 and 40 do not form a part of the inventive base; the base can be used with other types and styles of rolling cart working and intermediate sections.

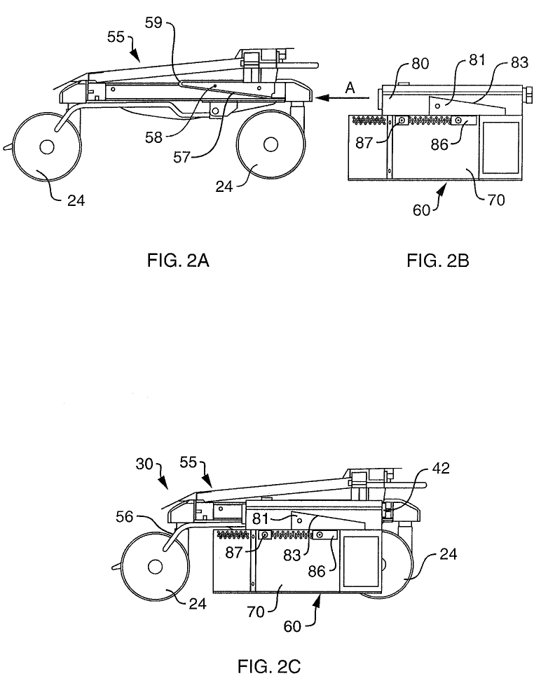

Rolling base section 30 comprises two main assemblies: rolling base and battery support assembly 55, and battery/electronic assembly 60 that mates with and is held in place on assembly 55 (FIGS. 2A-2C). The two mate by including brackets on each of assemblies 55 and 60 that define mating ramp surfaces such that when battery/electronics assembly 60 is pushed onto base assembly 55, the ramps engage, with the ramps on assembly 60 sliding along the ramps on assembly 55. This causes assembly 60 to be lifted about ¾ of an inch off the floor. When the two are held in place as is explained below, assembly 60 is carried low on the cart where it serves to counterbalance the weight carried by the cart upper section 20. Also, the combination of the gently-sloped ramping action and the placement very close to the floor minimizes the effort by and potential injury to the person installing the power source on the cart. The invention thus makes the cart easier and safer to manufacture, and more useful.

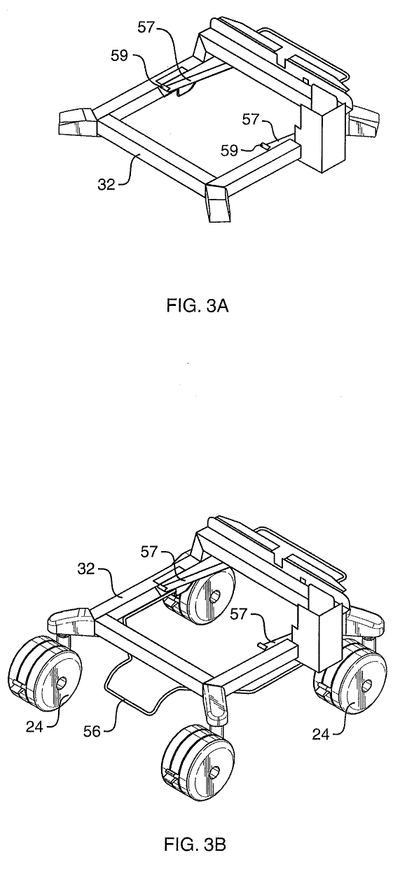

FIGS. 3A through 3C show stages of assembly of rolling base and battery support assembly 55. Assembly 55 comprises a generally rectangular frame member 32 to which is mounted four casters or wheels 24. Assembly 55 is shown in FIG. 3C. Foot pedal 56 is included to release an internal gas spring (not shown) that allows manual adjustment of the height of the rolling cart through alteration of the length of telescoping intermediate section 40; such adjustment is the subject of a separate patent application entitled “Single-Post, Height Adjustable Cart” filed on even date herewith, attorney docket number 18235-00039, the entire contents of which are incorporated herein by reference. Cover 53 for frame member 32 is included primarily for aesthetic purposes.

The ramp detail of base assembly 55 is shown in FIG. 3A, and comprises a ramp 57 connected to each side of the interior of open frame 32, sloping down toward the back of frame 32, away from front foot pedal 56.

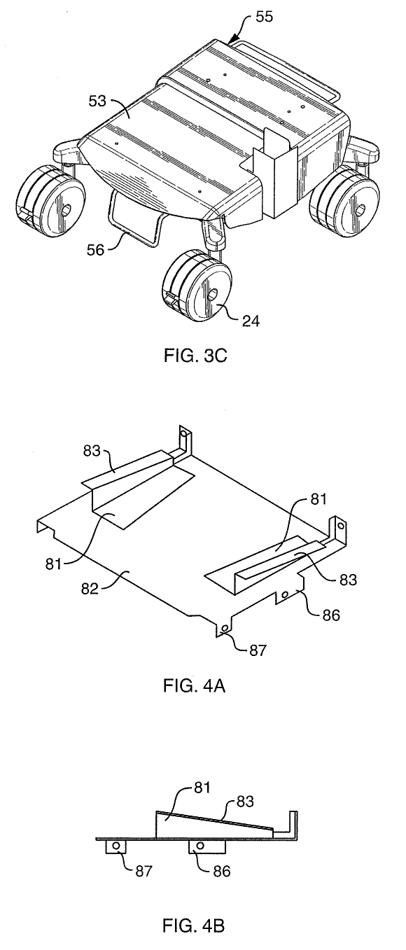

Power supply assembly 60 is shown in FIGS. 2, 4 and 5. Assembly 60 can weigh on the order of forty to fifty pounds. Battery cell enclosure 70 carries a rechargeable battery power source (not shown); in one embodiment this comprises four rechargeable twelve-volt batteries connected in series. Electronics case 80 carries at least power conditioning and distribution electronics used to supply power from the batteries to electrically-powered equipment coupled to or carried by the cart. Case 80 is mounted to enclosure 70 with bracket 82. Bracket 82 is screwed into the bottom of case 80, then attached to enclosure 70 with screws passing through ears 86 and 87 located on both sides of bracket 82; only one set of ears is visible in FIG. 4A. Ramp members 81 are properly spaced such that the two integral ramp flanges 83 are located such that they will directly engage with ramps 57.

To mount assembly 60 to assembly 55, assembly 60 is pushed into the open back under frame 32, in the direction of arrow A, FIG. 2B. The undersides of the two ramp flanges 83 contact the upper sides of the two ramps 57. As assembly 60 is pushed farther into assembly 55, the mating ramps cause the power supply to lift off the ground. When the two are pushed together all the way until stop 59 is contacted, ramps 57 support assembly 60. Then, tongue 42, FIG. 2C (which is simply a metal tab that is coupled to the cart with a screw or rivet and able to pivot about a horizontal axis), is pivoted from a horizontal or vertical position to a downward position as shown in the drawing, such that at least a portion of tongue 42 is located behind electronics case 80. This prevents battery/electronics assembly 60 from sliding down back to the floor.

Ramp flanges 83 are sloped at about an eight-degree angle, and are about six inches long. This construction is sufficient to lift assembly 60 about 0.75 inches off of the floor. The shallow angle allows the installer to easily push the 40-50 pound assembly 60 up the ramps to lift assembly 60 about 0.75 inches over the course of travel of about six inches, even though the ramp-to-ramp, metal-to-metal contact creates quite a bit of friction force. The result is that the simple construction, with two sets of two, spaced ramps on each of the inter-engaging members, does not require rollers or wheels as are typically used when engaging battery packs with wheeled vehicles.

The result is an easily-mountable, removable, rechargeable battery-based power supply that can be plugged into a wall outlet to recharge the battery using a power cord (not shown), and has one or more AC outlets (not shown) that can be used to power a computer, monitor or other devices, typically ones that are carried by the cart, such as shown in FIG. 1.

Although specific features of the invention are shown in some figures and not others, this is for convenience only, as some features may be combined with any or all of the other features in accordance with the invention.

Recitation of sizes, quantities, weights and ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A battery power supply mounting system for a rolling computer cart, comprising:
one or more ramp structures on the cart, located close to the bottom of the cart; and
a battery power supply assembly adapted to be mounted to the cart and comprising at least one rechargeable battery, and one or more power supply assembly ramps that directly engage with the one or more ramp structures on the cart as the power supply assembly is mounted on the cart, to lift the battery power supply assembly slightly as it engages with the ramp structures on the cart.

2. The power supply mounting system of claim 1 further comprising structure to hold the power supply assembly on the cart after the power supply assembly has been mounted on the cart.

3. The power supply mounting system of claim 2 in which the structure comprise a movable tongue.

4. The power supply mounting system of claim 1 in which the power supply assembly comprises a battery enclosure that contains one or more batteries, and an electronics case that holds electronic devices used to supply power from the batteries to electrically-powered equipment coupled to or carried by the cart.

5. The power supply mounting system of claim 4 in which the power supply assembly further comprises one or more power supply assembly brackets that mechanically couple together the electronics case and the battery enclosure.

6. The power supply mounting system of claim 5 in which the one or more power supply assembly brackets comprise the one or more power supply assembly ramps.

7. The power supply mounting system of claim 6 comprising one power supply assembly bracket that carries two spaced power supply assembly ramps.

8. The power supply mounting system of claim 1 in which the ramp structures and the power supply assembly ramps are at an angle of no more than about ten degrees.

9. The power supply mounting system of claim 8 in which the ramp structures and the power supply assembly ramps are at an angle of about eight degrees.

10. The power supply mounting system of claim 1 in which the ramp structures and the power supply assembly ramps are each about six inches long.

11. The power supply mounting system of claim 1 in which the ramp structures and the power supply assembly ramps cooperate to hold the power supply assembly less than about one inch off of the floor on which the cart is located.

12. The power supply mounting system of claim 1 in which the ramp structures define stops at their upper ends, to define an end position for the power supply assembly ramps.

13. The power supply mounting system of claim 1 comprising two spaces ramp structures and two spaced power supply assembly ramps.

14. A battery power supply mounting system for a rolling computer cart, comprising:
two spaced ramp structures on the cart, located close to the bottom of the cart; and
a battery power supply assembly comprising a battery enclosure that contains one or more rechargeable batteries, and an electronics case that holds electronic devices used to supply power from the batteries to electrically-powered equipment coupled to or carried by the cart, and a power supply assembly bracket that mechanically couples together the electronics case and the battery enclosure, in which the power supply assembly bracket comprises two power supply assembly ramps that directly engage with the two ramp structures on the cart as the power supply assembly is mounted on the cart, to lift the battery power supply assembly slightly as it engages with the ramp structures on the cart.

15. The power supply mounting system of claim 14 further comprising structure to hold the power supply assembly on the cart after the power supply assembly has been mounted on the cart.

16. The power supply mounting system of claim 15 in which the structure comprise a movable tongue.

17. The power supply mounting system of claim 14 in which the ramp structures and the power supply assembly ramps are at an angle of no more than about ten degrees.

18. The power supply mounting system of claim 17 in which the ramp structures and the power supply assembly ramps are at an angle of about eight degrees.

19. The power supply mounting system of claim 18 in which the ramp structures and the power supply assembly ramps are each about six inches long.

20. The power supply mounting system of claim 19 in which the ramp structures and the power supply assembly ramps cooperate to hold the power supply assembly less than about one inch off of the floor on which the cart is located.

21. The power supply mounting system of claim 20 in which the ramp structures define stops at their upper ends, to define an end position for the power supply assembly ramps.
